(19) United States
(12) Patent Application Publication
(10) Pub. No.: US 2010/0250446 A1
(43) Pub. Date: Sep. 30, 2010

(54) FREIGHT COMMERCE SYSTEM AND METHOD

(75) Inventors: Patricia Denise Mackenzie, Clifton Park, NY (US); Joseph Edward Jesson, Hamilton Square, NJ (US); Joseph James Salvo, Schenectady, NY (US); Kimberley Marie Mangino, Niskayuna, NY (US); Robert August Graziano, Niskayuna, NY (US); Charles Burton Theurer, Alplaus, NY (US); Olga Ratsimor, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: General Electric Company, Schenectady, NY (US)

(21) Appl. No.: 12/415,997

(22) Filed: Mar. 31, 2009

(51) Int. Cl. G06Q 30/00; G06Q 50/00; G06Q 10/00; G01C 21/00

(52) U.S. Cl. 705/80; 705/26; 705/11; 700/300

(57) ABSTRACT

In certain embodiments, a freight commerce system is provided. The freight commerce system includes a server communicatively coupled to a communication network. The freight commerce system also includes one or more data collection devices communicatively coupled to the communication network. The one or more data collection devices are configured to provide location information to the server via the communication network, wherein the location information includes real-time geo-based information, historical geo-based information, or a combination thereof. In addition, the freight commerce system includes one or more electronic devices coupled to the communication network and configured to receive user preference information from a user and provide the preference information to the server. The server is configured to process the user preference information from the one or more electronic devices and the location information from the one or more data collection devices and provide the user with information for potential shipping business partners based on the user preference information and the location information.

### BACKGROUND OF THE INVENTION

The subject matter disclosed herein relates generally to a freight commerce system and method and, more specifically, to a freight commerce system that includes real time geo-based information.

Large freight companies typically have the ability and resources to organize shipments and schedules of their freight carriers to maximize efficiency. Dispatchers may communicate directly with the carriers to arrange and coordinate pick-up and drop-off of loads to reduce down time. They may consolidate routes to minimize the amount of time and distance that a particular carrier travels without a load. Additionally, they may maximize the amount of goods that are being carried along particular routes by the carriers.

In contrast, small carriers, small shippers, and individual drivers are unable to take advantage of efficiencies of scale afforded to the large freight companies. There is no simple, user-friendly mechanism that allows the small owner/operator carriers to find loads and small shippers to find carriers that fit into their schedules and meet other personalized requirements. For example, currently, drivers may use brokers, bulletin boards, or other rudimentary discovery mechanisms to identify potential loads. There is no automated or semi-automated way for them to optimize their schedule or negotiate contract details.

In particular, many current systems are limited to electronic bulletin boards, such as a Trans-core Exchange powered by DAT that brokers use to identify supply and demand for freight services. Additionally, U-Ship provides a web auction that allows shippers to post delivery request for drivers to bid on. Load Direct provides service kiosks located at truck stops that allow drivers to brows bulletin boards for loads. However, none of the current systems enable personalized requirements of the small owner/operator carriers and/or shippers and receivers. For example, shippers are not provided the tools to track the status of a load once it has left their yard. Thus, shippers and receivers do not know the real-time location of a load, estimated time of arrival of the load, temperature of the load, if there are other loads in the trailer, if the load is compatible with the other loads in the trailer, the number of times the trailer was opened en route, and so forth.

### BRIEF DESCRIPTION OF THE INVENTION

In a first embodiment, a freight commerce system is provided. The freight commerce system includes a server communicatively coupled to a communication network. The freight commerce system also includes one or more data collection devices communicatively coupled to the communication network. The one or more data collection devices are configured to provide location information to the server via the communication network, wherein the location information includes real-time geo-based information, historical geo-based information, or a combination thereof. In addition, the freight commerce system includes one or more electronic devices coupled to the communication network and configured to receive user preference information from a user and provide the preference information to the server. The server is configured to process the user preference information from the one or more electronic devices and the location information from the one or more data collection devices and provide the user with information for potential shipping business partners based on the user preference information and the location information.

In a second embodiment, a method for operating a freight commerce system is provided. The method includes receiving real-time data from a plurality of data devices via a communication network. The data devices are located with goods or carriers. The method also includes receiving preference data from carriers and shippers via the communication network. In addition, the method includes processing the real-time data from the plurality of data devices and the preference data from the carriers and shippers. The method also includes providing carriers and shippers with a recommendation list based at least in part on the real-time data and preferences data.

In a third embodiment, a shipping management system is provided. The shipping management system includes a data collection system. The data collection system includes a data collection device configured to obtain real-time data relating to a shipment load. The data collection system also includes a communication network configured to transmit the real-time data. In addition, the data collection system includes a central station configured to collect the real-time data. The shipping management system also includes a server configured to receive the real-time data, to receive preference information from carriers or shippers via the communication network, to process the real-time data and the preference information, to learn behavioral characteristics of the carriers or shippers based at least in part on the real-time data and the preference information, and to provide the carriers or shippers with a recommendation list based at least in part on the learned behavioral characteristics of the carriers or shippers.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an exemplary embodiment of a freight commerce system;

FIG. 2 is a block diagram of an exemplary embodiment of the freight commerce system illustrated in FIG. 1;

FIG. 3 is a block diagram of an exemplary embodiment of a server of the freight commerce system;

FIG. 4A is a flow chart of an exemplary embodiment of a method for operating the freight commerce system;

FIG.4B illustrates actors that may provide information to the freight commerce system in accordance with the method of FIG. 4A;

FIG. 5A is an exemplary driver's profile form for use with the freight commerce system;

FIG. 5B is another portion of the exemplary driver's profile form of FIG. 5A;

FIG. 5C is yet another portion of the exemplary driver's profile form of FIGS. 5A and 5B;

FIG. 6A is an exemplary map interface for the freight commerce system; and

FIG. 6B illustrates exemplary results for a selection screen of the map interface of FIG. 6A.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include a freight commerce system and methods which enable carriers, drivers, shippers, and receivers to interact within a virtual market place and offer a set of tools that enable personalized, customizable, real-time negotiations and contract agreements. The freight commerce system provides features such as business partner discovery, contract negotiations, multi-hop schedule recommendations, and telematics-infused supply chain optimizations. The freight commerce system enables users to base negotiations on real-time geo-based information, analysis of historical geo-based information, user calibrated preferences, performance metrics, and inputs from all actors, as will be described in detail below. In addition, the freight commerce system may include the capability of being able to adaptively learn from user preferences, past user performance, and so forth.

The real-time capabilities of the freight commerce system may be based on data provided by real-time tracking devices associated with a real-time tracking system, such as the VeriWise™ from General Electric, for example. The real-time tracking system may provide actors with the ability to discover each other. For example, a shipper may be able to find carriers that are currently located near the shipper. This may be useful in the event that a particular shipment is a rush shipment, as the carrier may already be in the vicinity of the shipper. Additionally, implementation of the real-time tracking system within the freight commerce system may allow for historical data to be gathered regarding carriers. For example, data such as routes taken, goods carried, and on-time services may create a historical profile useful to shippers that are seeking carriers. In addition, the real-time tracking system may include real-time monitoring of load location, load status, load condition, and so forth.

It should be noted that, as used herein, the term “real-time” is not intended to be limited to data and transactions which occur substantially instantaneously (e.g., measured in microseconds). Rather, in the specific context of the freight commerce system presented herein, as well as the logistics domain in general, the term “real-time” can mean up to 24 hours in certain circumstances. Indeed, in the present context, the term “real-time” may be taken as anything from a few seconds to the latest relevant information.

The freight commerce system may also aid in negotiations between carriers and shippers. For example, each actor may have a unique set of multi-attribute preferences for each negotiation they enter into. In one example, a carrier may attempt to optimize workload and maximize profits by negotiating with multiple shippers in parallel. Similarly, the shipper may be able to examine a set of proposals from multiple carriers or drivers, and each actor may make decisions based on personal multi-attribute preferences. In addition, the freight commerce system may also use real-time geo-based information to aid in negotiations.

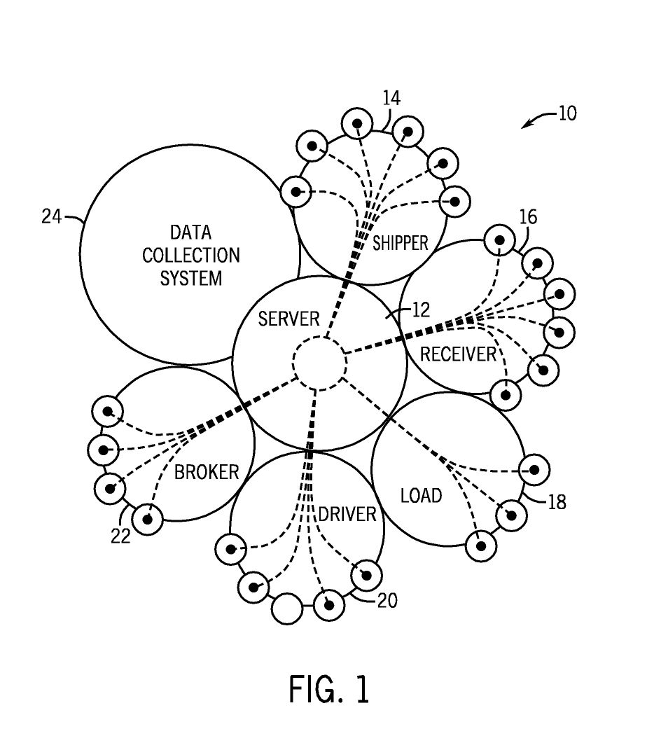

Turning to the figures, and referring initially to FIG. 1, an exemplary embodiment of a freight commerce system 10 is shown. The freight commerce system 10 includes a server 12, which may serve as a central feature of the freight commerce system 10 as each of the actors in the freight commerce system 10 may provide data to and receive data from the server 12. The actors in the freight commerce system 10 may include a shipper 14, a receiver 16, a load 18, a driver or carrier 20, and a broker 22. Although each actor is depicted in FIG. 1 as a single entity, the shipper 14, the receiver 16, the load 18, the driver or carrier 20, and the broker 22 may, in fact, include a plurality of individual actors (e.g., shippers 14, receivers 16, loads 18, drivers or carriers 20, brokers 22, and so forth). Additionally, the freight commerce system 10 may include a data collection system 24, which will be described in greater detail below. The data collection system 24 may be, for example, the VeriWise™ system mentioned above.

The freight commerce system 10 may be configured to manage preferences and personal profiles for each of the actors. Specifically, a personal profile for the driver 20 may contain basic facts such as years of experience, license type, average load value, customer feedback, ratings, reliability, references, credentials, and so forth. Additionally, the driver's personal profile may include preferences such as preferred trip distance, preferred load types, and so forth. Some of the details may be provided by the driver 20, while other details, such as average load value, may be computed by the server 12 over a period of time. The shipper 14, on the other hand, may complete a profile that contains basic facts such as shipper's location, hours of operation, and so forth, and preferences such as preferred load handling practices, and/or preferred hours of load pick up. A receiver 16 may complete a profile that may contain similar facts, and may also include the number of loading docks at the facility, and preferences such as the use of certain loading docks for different loads for different shippers, preferred delivery schedule, and so forth.

The preference information may be used to influence negotiation and assist in comparative valuations of competing proposals set forth by both shippers and carriers. Furthermore, the preference information may be used by the server 12 to provide contract and agreement templates to allow the users to enter into freighting agreements. In one embodiment, a valuation matrix that reflects the immediate preferences of each of the actors may be maintained by the freight commerce system 10 and may be used in a comparative evaluations process. As discussed in greater detail below, the preference information may be added to the freight commerce system 10 either automatically (e.g., by tracking a user's behavior), or manually input by a user into a custom interface of the freight commerce system 10 or through a general user interface (e.g., web browsers, and so forth).

In the valuation matrix, preferences are weighted and the score of a given opportunity is valued based on that weighting. Preferences to be weighted can include any of the factors in the system including, but not limited to, driver qualifications (license type, on-time performance, language, and so forth), shipper qualifications (timeliness of payments, ease of working relationships, and so forth), shipper needs (on time delivery, and so forth), as well as other similar factors related to carriers 20 and loads 18. A summation across all references may then enable the system to compare opportunities. The weightings may be either user-entered or learned. A “learned” weighting is created by determining what the user has previously selected as choices and/or which choices have brought benefit to the user. The manual weightings that go into the valuation matrix may be dynamic and may be changed to meet any short-term need. For example, a shipper 14 may weight “reliability of delivery” higher and “on-time delivery” lower. Therefore, an opportunity requiring that a load absolutely be delivered, with less emphasis on timing, will be scored higher. Similar examples may be generated for the carrier 20 or the load 18 itself. The valuation matrix may encompass all of the actor interactions. Therefore, the suitability of the carrier 20 for a given load 18 may be evaluated (e.g., how well the carrier 20 meet the requirements of the load 18) and vice versa (e.g., how suitable is the load 18 for the carrier 20, what the carrier 20 gains by carrying this load 18, and so forth). All of the interactions (shipper-carrier, shipper-driver, and so forth) have this two-way element and all such interactions are included in the valuation matrix. The net result is the score given to the potential transaction.

The freight commerce system 10 may also facilitate a reputation feedback mechanism for all of the actors so that reputations can be factored into the comparative evaluations during negotiations. For instance, a driver's reputation may be built as a composite of inputs from shipper's feedback, receiver's feedback, and so forth. The inputs can have both manual and automated components. For example, the shipper 14 may manually rate the carrier 20 on professionalism at the time of pick up. In addition, the receiver 16 may manually rate the carrier 20 on his ability to deliver to the correct dock door. Additionally, the carrier 20 can rate the shipper 14, receiver 16, and even the load 18. For example, the carrier 20 may rate the shipper 14 and receiver 16 on professionalism and the load 18 based on compatibility with other loads, packaging, ease of transport, and so forth. As such, in certain embodiments, the valuation matrix may enable a multiple attribute reputation building mechanism based on geo-based historical and real-time information (e.g., on time delivery, and so forth) as well as user feedback and other data inputs, discussed in greater detail below.

Automated inputs from the data collection system 24 may include, for example, timeliness of delivery, adherence to route, previous experience in that geographic area (i.e. from historical data gathered through the data collection system 24) or with a particular pick-up or delivery location, sensor data on the load 18 (such as excess impact, temperature history, etc.). Thus, the data collection system 24 may include electronic devices configured to provide location information, for example, satellite-based or cellular-based devices, among others.

Additionally, in certain embodiments, the load 18 may act as an active actor in the freight commerce system 10 and may provide data to the data collection system 24 such as temperature, mishandling, and so forth, based on signals from sensors (e.g., thermometers, accelerometers, and so forth) located on or near the load 18. In such systems, the load 18 may be provided with a radio frequency identification (RFID) tag that contains information related to the shipping of the load 18. For example, the RFID tag may indicate temperature constraints, handling instructions, and so forth. Alternatively, a shipper 14 or receiver 16 may provide handling instructions to the server 12 on behalf of the load 18. The data relating to the load 18 may be used in a number of instances. For example, the load 18, receiver 16, and shipper 14 may have opposing sets of preferences. A load 18 and receiver 16 may prefer the load 18 to travel in a protective environment and arrive safely at its destination. On the other hand, the shipper 14 may not care about the load's accommodations but, rather, cost and time of delivery. Allowing the load 18 to participate as an active actor may, thus, help to insure that all actors achieve desired efficiencies.

In addition to the foregoing features, the freight commerce system 10 may be configured to facilitate personalized optimization over multiple route schedules. For example, the driver 20 may be able to build a chain of routes that will provide a particular benefit desired by the driver 20. This type of optimization will enable the driver 20 to develop and execute a personalized long-term strategy that may focus on individual goals and needs. For example, if the driver 20 desires to build up experience in transporting particular goods, such as fragile goods, the freight commerce system 10 may be configured to suggest a multi-stepped schedule of deliveries that will maximize the number of loads 18 that are considered fragile. Upon completion of each of these steps, the driver's record and/or reputation may reflect improvements in the driver's qualifications, thus, making his or her skill set more marketable. In particular, these needs of the driver 18 to build experience and/or reputation may be adaptively learned and, further, the freight commerce system 10 may make future recommendations based on the learned needs. Furthermore, this same type of learning based on any of the actors' actions may be accomplished by the freight commerce system 10.

Additionally, the freight commerce system 10 may allow for hedging via bulk route pre-buying. To hedge, a hedger may contract to provide freight services for a particular volume on a particular route for a particular period of time. Because of the uncertainty of bulk rate purchasing, the hedger may be able to negotiate a favorable price for such services. The hedger may later benefit from either re-selling the route at a lower price due to reduced market demand or executing it in a lower cost environment due to external factors, such as, lower fuel costs. A small business operator would not typically be in a position to benefit from this type of strategy.

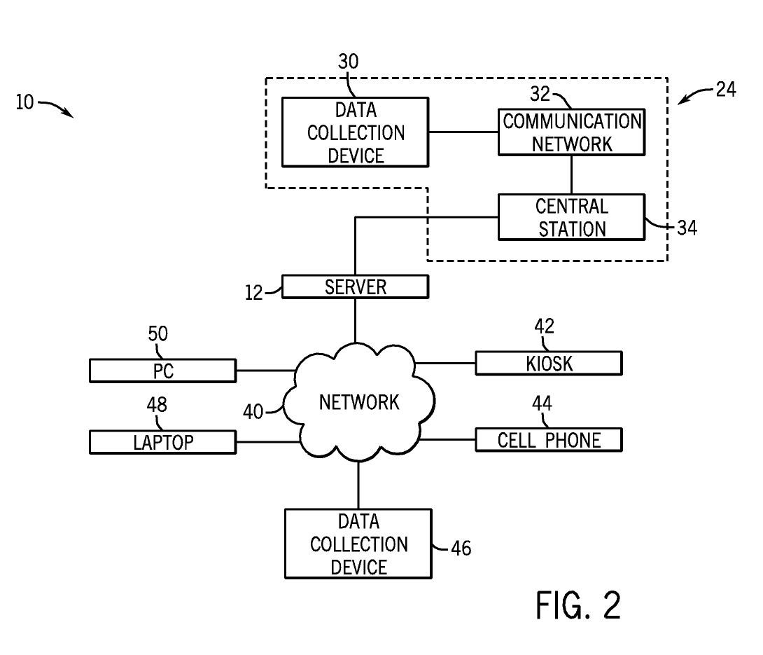

FIG. 2 is a more detailed block diagram of an exemplary embodiment of the freight commerce system 10 illustrated in FIG. 1. The freight commerce system 10 is illustrated as including the server 12 and the data collection system 24. The data collection system 24 may include a data collection device 30, a communication network 32, and a central station 34. The data collection device 30 may be a wireless transmitter device, configured to obtain data related to a truck, a trailer, or a load 18. For example, data collected may include the temperature of a trailer and/or the load 18, load vibration and impact events, access to a storage area of the trailer and location of other events, driver performance (e.g., speed, hard braking, and so forth), transportation asset condition (e.g., tire pressure, brake wear, bearing wear, anti-lock braking system use, and so forth), among other things. Additionally, the data collection device 30 may be configured with location-indicating capabilities. Thus, the data collection device 30 may indicate current location, a transportation route, deviation from a negotiated transportation route, as well as estimated delivery time. In accordance with the disclosed embodiments, the data collection device 30 may operate as a satellite-based system, a wireless internet system, a radio frequency (RF) system, or any other suitable communication system. As such, the communication network 32 may include satellites, WiFi antennas, RF antennas, or any other compatible communication technology.

The communication network 32 may be coupled to the central station 34, which may include a server, database, and/or relay switches for handling the data provided by the data collection device 30. The central station 34 may be configured to not only collect data from the data collection device 30 but also parse, sort, and/or process the data for use by the server 12. Alternatively, the central station 34 may simply be a communication link for relaying the data from the data collection device 30 to the server 12. As such, in certain embodiments, the data collection system 24 may be coupled to the server 12 via a network, such as network 40.

The network 40 may be any suitable communication network. In particular, the network 40 may include a variety of components and/or connections such as servers, fiber optics, cables, and wireless communication devices. Additionally, the network 40 may include a variety of networks including LANS, WANS, and the Internet. The network 40 allows for the server 12 to be coupled to kiosks 42, cell phones 44, data collection devices 46, laptop computers 48, and PC computers 50, among other things.

Actors in the freight commerce system 10 may communicate with the server 12 via any electronic device coupled to the network 40. In particular, actors such as drivers 20 may access a kiosk 42, which may be located in a truck stop, for example. The driver 20 may input preference data, as discussed above, and/or negotiate contracts or select loads for transportation in accordance with the disclosed embodiments. Alternatively, the actor may use a cell phone 44 or any electronic device enabled to access the Internet. Additionally, a data collection device 46 may be configured to enable the user to access the server 12 via the network 40 to provide preferential data as well as feedback and other information in accordance with the disclosed embodiments.

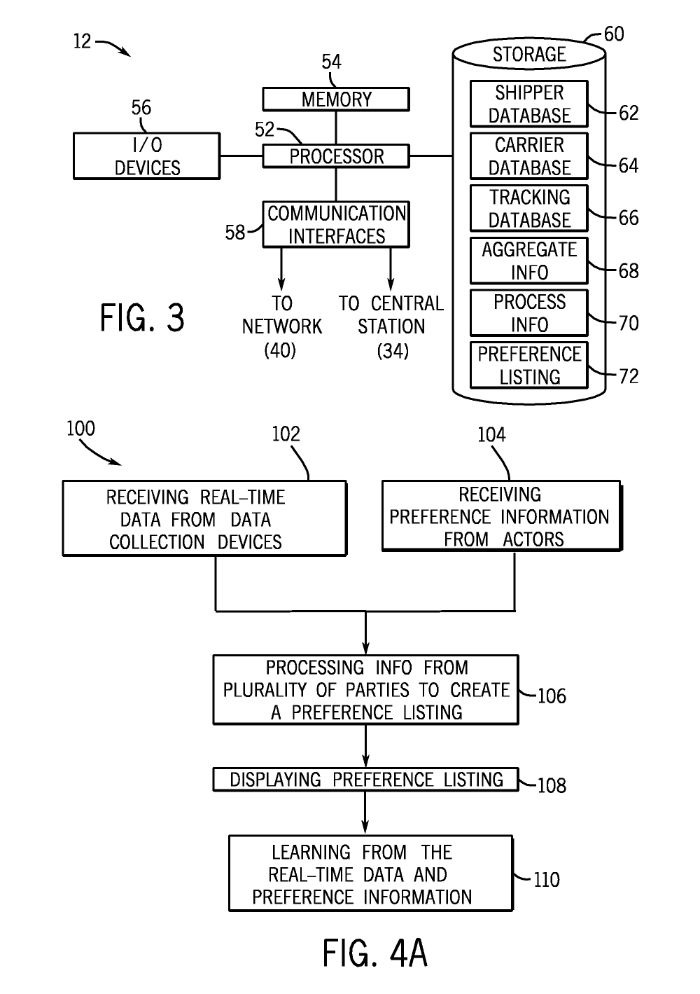

FIG. 3 is a block diagram of an exemplary embodiment of the server 12 of the freight commerce system 10. The server 12 may include a processor 52 coupled to a memory 54, 1/0 devices 56, communication interfaces 58, and storage devices 60. The processor 52 may be one or more processors configured to execute commands stored in the memory 54 to provide the functionality described herein. The memory 54 may be any suitable memory and may include hard drive storage memory as well as random access memory (RAM), among others known. The 1/0 devices 56 may enable a user to interface with the server 12 and the communication interfaces 58 may be configured to communicate with the network 40 and the central station 34, for example.

The storage devices 60 may be any electronic or magnetic storage device and may include a shipper database 62, a carrier database 64, a tracking database 66, as well as algorithms, software, and/or programs to aggregate information 68, process the information 70, and generate preference listings 72, as will be described in greater detail below. The shipper database 62 may include all information related to shippers 14 including preferential data, feedback data and historical data regarding contracts entered into, for example. The carrier database 64, may include all carrier information, including preferential data, feedback, and historical information, for example. The tracking database 66 may include all information related to loads 18, trailers, cabs, other devices, and/or actors, for which tracking data may be provided.

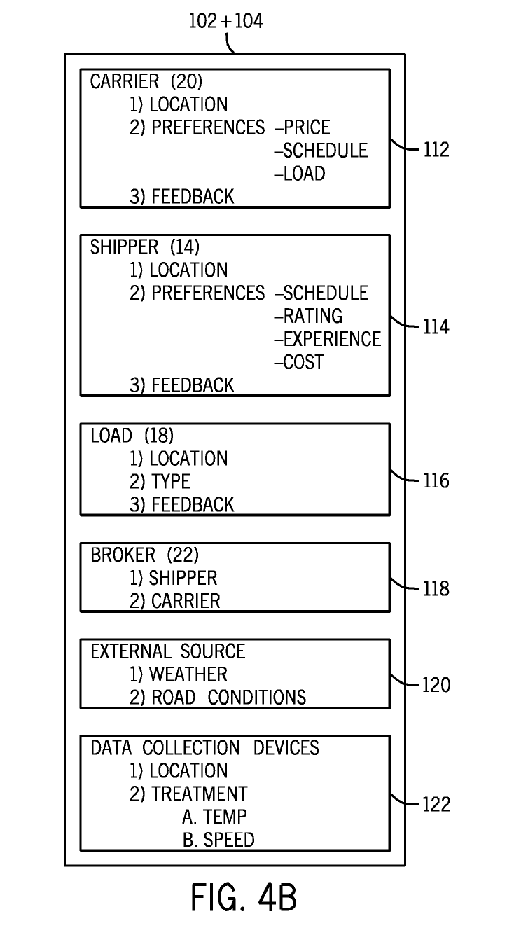

FIG. 4A is a flow chart of an exemplary embodiment of a method 100 for operating the freight commerce system 10. The method 100 may begin with the server 12 receiving real-time information related to a service from data collection devices, as indicated at block 102. Preference information may also be received from the actors, as indicated at block 104. Thus, the freight commerce system 10 is configured to receive both automatic inputs from devices and manual inputs from users and to aggregate the information for use by the freight commerce system 10. It should be noted that steps 102 and 104 of the method 100 may be performed concurrently. In fact, all of the steps of the method 100 may, to a certain degree, be performed continually in an iterative fashion.

FIG. 4B illustrates in more detail steps 102 and 104 of the method 100 by showing the actors of the freight commerce system 10 along with the data that may be provided from each of the actors. Specifically, as shown in block 112, a carrier 20 may provide information including location, preferences (e.g., price, schedule, load types, and so forth), as well as feedback. The shipper 14, as indicated at block 114, may indicate location, preferences (e.g., schedule, rating, experience, costs, and so forth), as well as feedback. A load 18, as indicated at block 116, may indicate a location, type, as well as feedback relating to treatment and/or other variables. The information provided by the load 18 to the server 12 may be automated. As indicated at block 118, a broker 22 may provide similar information regarding both shippers 14 and carriers 20 and may utilize the freight commerce system 10 to facilitate its business. Additionally, external sources 120 may provide information to the server 12. The external sources 120 may provide information such as weather conditions, road conditions, and other information that may not be known by other actors. The data collection devices 122, as described above, may provide information including location, temperature, speed, stops, and so forth. Other actors may be included in accordance with alternative embodiments, and indeed, not all of the actors need participate in order for the freight commerce system 10 to function.

Returning to FIG. 4A, once information has been aggregated as indicated at blocks 102 and 104, the information may be processed, as indicated at block 106, to create a preference listing in accordance with the preferences of the various actors. As described below, the preference listing may include a numerical assignment indicative of a relative number of preferences for a particular actor included in the preference listing. The preference listing may then be displayed, as indicated at block 108, so that actors of the freight commerce system 10, e.g., shippers 14, carriers 20, brokers 22, and so forth, may enter into negotiations or bid for services of other actors of the freight commerce system 10. Numerical assignment is based on the above-mentioned valuation matrix. The manual weightings that go into the valuation matrix may be dynamic and may be changed to meet any short-term need. The net result is the score given to the potential transaction. The user may be provided with the top choices (e.g., those choices that scored highest on the valuation matrix). As such, the freight commerce system 10 may enable automated discovery of collaboration opportunities, enabled by the availability of real-time data and historical geo-based information.

Furthermore, in certain embodiments, the method 100 may include using the real-time data from the data collection devices and the preference information received from the actors to adaptively learn from the real-time data and preference information, as indicated at block 110. In addition, the method 100 may also learn from historical data (e.g., historical data collected from the data collection devices and historical preference information). This learning aspect of the freight commerce system 10 may enable validation of the preference information. In addition, the learning aspect may be used to supplement the preference information. For example, the freight commerce system 10 may recommend actions to a user, such as by learning user preferences based on the user's previous selections, accepting a less than desirable load in order to build reputation in a weaker area of competence, picking a less than desirable carrier 20 that still meets risk criteria at an acceptable cost point, and so forth. Since the freight commerce system 10 is able to learn from the real-time data and the preference information, the freight commerce system 10 may be able to make recommendations based not only on the preference information, but also based on the learned behavioral characteristics (e.g., behavioral patterns, and so forth).

In particular, in certain embodiments, the freight commerce system 10 may be configured to provide a forum for actors to negotiate for services. For example, a shipper 14 may provide preference information related to a particular shipment. Through the freight commerce system 10, carriers 20 that meet (or most closely approximate) the preferences set by the shipper 14 may be listed for review by the shipper 14. As described earlier, the preference listing may take into account real-time location information. The shipper 14 may be able to contact one or more of the listed carriers 20 after reviewing credentials (e.g., experience, licenses, ratings, and so forth) and/or carrier preferences. The freight commerce system 10 may be configured to provide an analogous procedure to allow a carrier 20 to find shippers 14.

Alternatively, the freight commerce system 10 may provide some variant of an auction for services to allow actors to bid for services. For example, a shipper 14 may provide preferences as to a particular shipment and the freight commerce system 10 may be configured to list the particular shipment in an electronic forum for auction. Upon using the freight commerce system 10 to find loads 18, carriers 20 fitting the preference profile may bid to carry the shipment for the shipper 14. The freight commerce system 10 may be configured to allow the shipper 14 to review the bids, credentials (e.g., experience, rating, licenses, and so forth) and preferences of the carrier 20 before accepting a bid. As such, the auction may not necessarily go to the highest bidder, but may allow a shipper 14 to achieve a preferred pricing while still achieving preferences for the shipment.

Other functionality may also be provided, including a “Ship Now” option that automatically allows a carrier 20 that meets a particular price to automatically win the auction. Additionally, a shipper 14 may set a reserve price, starting bid price, and so forth. Again, the freight commerce system 10 may be configured to provide an analogous procedure for a carrier 20 to find shippers 14.

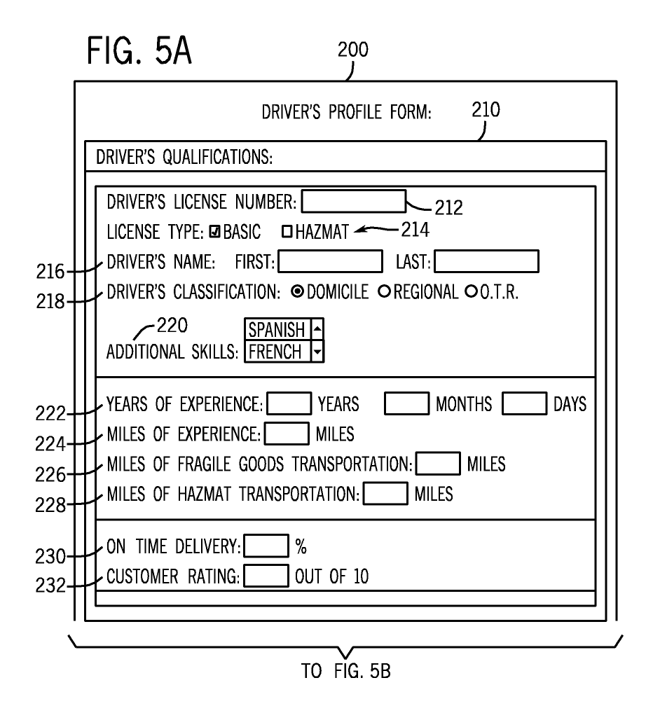

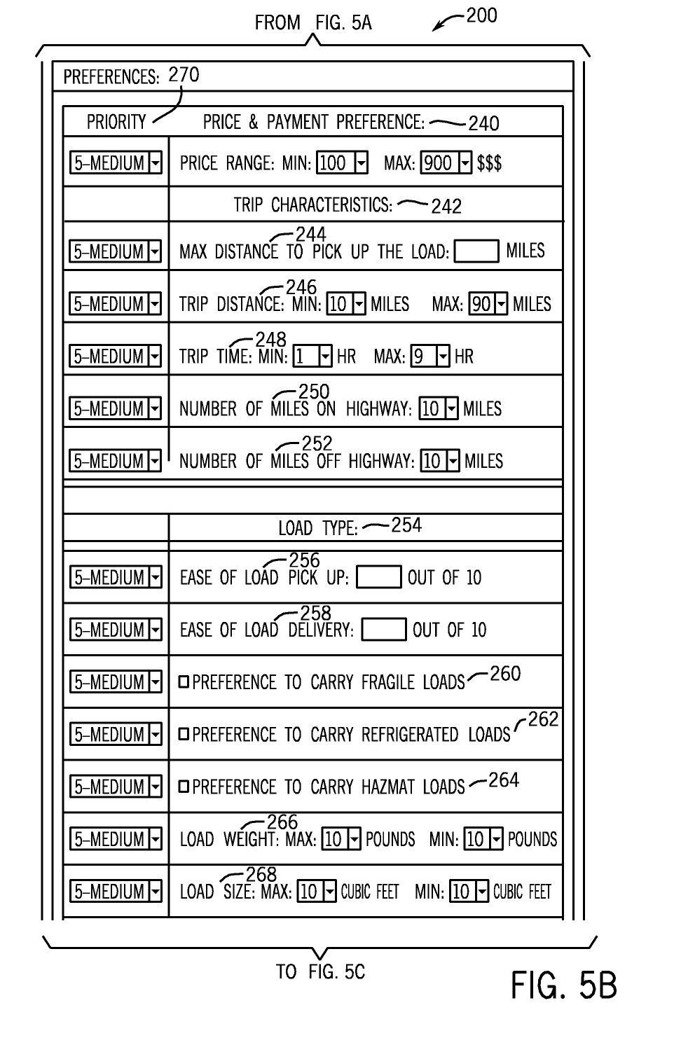

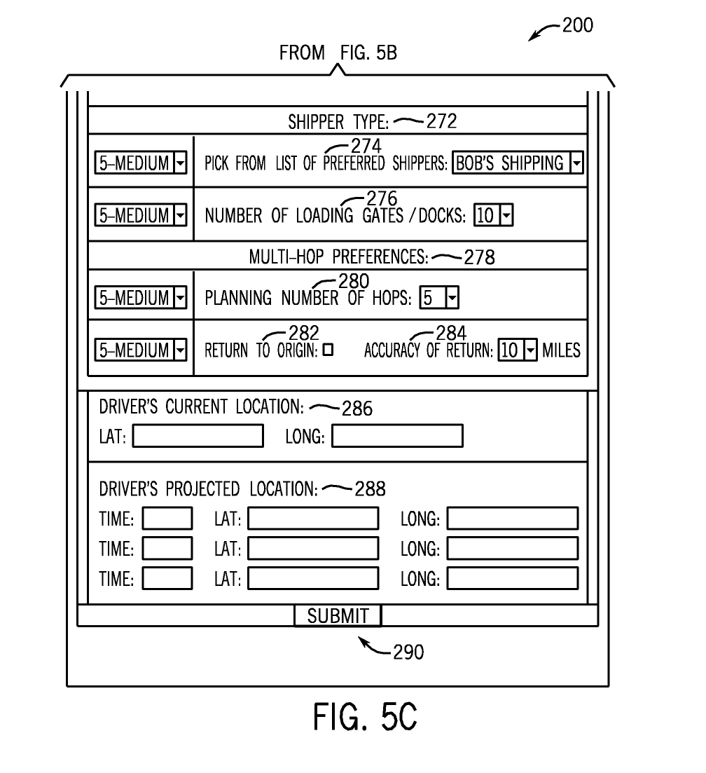

FIG. 5A is an exemplary driver's profile form 200 for use with the freight commerce system 10. The driver's profile form 200 may be accessible via a custom interface of the freight commerce system 10, a general user interface (e.g., web browsers, and so forth) or any other suitable interface. As described above, the driver's profile form 200 may allow for a driver 20 to provide facts and preferences to the server 12 for aggregation and processing purposes. The driver's profile form 200 may include the driver's qualifications 210, which may include a driver's license number 212, license type 214, the driver's name 216, the driver's classification 218, and additional skills 220 (e.g., foreign languages spoken, and so forth). Additionally, the driver's qualifications 210 may include years of experience 222, miles of experience 224, miles of fragile goods transportation 226, miles of hazardous materials (HazMat) transportation 228, percentage of on time deliveries 230, and customer rating 232. This information may enable other actors to make a determination as to whether or not to use a particular driver 20.

Additionally, FIG. 5B is a continuation of the exemplary driver's profile form 200 of FIG. 5A, which provides an opportunity for a driver 20 to select preferences for the freight commerce system 10. Specifically, a driver 20 may indicate price and payment preferences 240 (e.g., a minimum and maximum price range). In addition, a driver 20 may indicate trip characteristics 242 that are important to the driver 20. These trip characteristics 242 may include maximum distance to pick up the load 244, specific trip distance 246, estimated trip time 248, number of miles on the highway 250, and number of miles off the highway 252. Additionally, a driver 20 may indicate the load type 254, which may include ease of load pickup 256, ease of load delivery 258, preference to carry fragile goods 260, preference to carry refrigerated loads 262, preference to carry HazMat loads 264, load weight 266, and load size 268. In addition, the driver 20 may indicate skills and reputation areas upon which he wants to improve.

Additionally, a driver 20 is provided an opportunity to prioritize each of the variables in accordance with preferences. Specifically, in the left hand column a priority menu 270 is shown next to each of the various preference variables. The priority allows for a driver 20 to indicate what is most important to the particular driver 20 on a scale of 1 to 10, for example. Although shown as a drop down menu, the priority menu 270 may be implemented in other forms, such as a sliding bar, for example. Preference weightings are used when evaluating the suitability of a given potential transaction. As described above, the valuation matrix encompasses all of the actor interactions. Therefore, all of the interactions (e.g., shipper-carrier, shipper-driver, and so forth) have a two-way element and all such interactions are included in the valuation matrix. The net result is the score given to the potential transaction.

FIG. 5C is yet another continuation of the exemplary driver's profile form 200 of FIGS. 5A and 5B, which enables a driver 20 to indicate shipper type 272, including a list of preferred shippers 274 and number of loading gates/docks 276. In addition, a driver 20 may indicate multi-hop (e.g., multiple stop) preferences 278, including planning number of hops 280, whether or not to return to origin 282, and accuracy of return 284. Additionally, a driver 20 may indicate a current location 286 by inputting a latitude and longitude. Alternatively, a driver 20 may indicate a location by selecting a location on a map, as will be described in greater detail below. A driver 20 may also indicate a driver's projected location 288 by indicating latitude and longitude, as well as an anticipated time of arriving at the projected location. Once the driver's profile form 200 is completed, a driver 20 may submit the form electronically by selecting a submit icon 290.

Although only the driver's profile form 200 is given as an example, a shipper 14, receiver 16, broker 22, load 18, and so forth, may have similar forms that address the particular preferences of the actor, as described above.

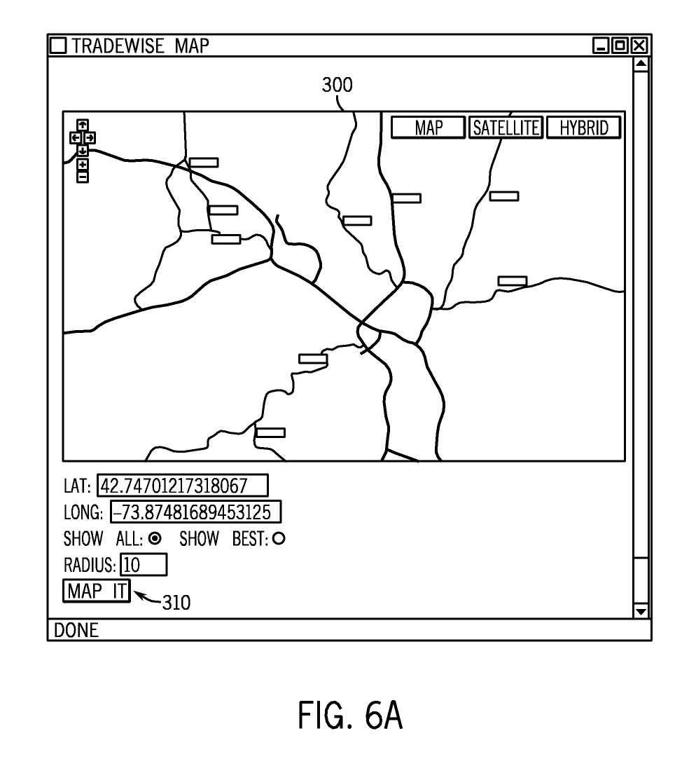

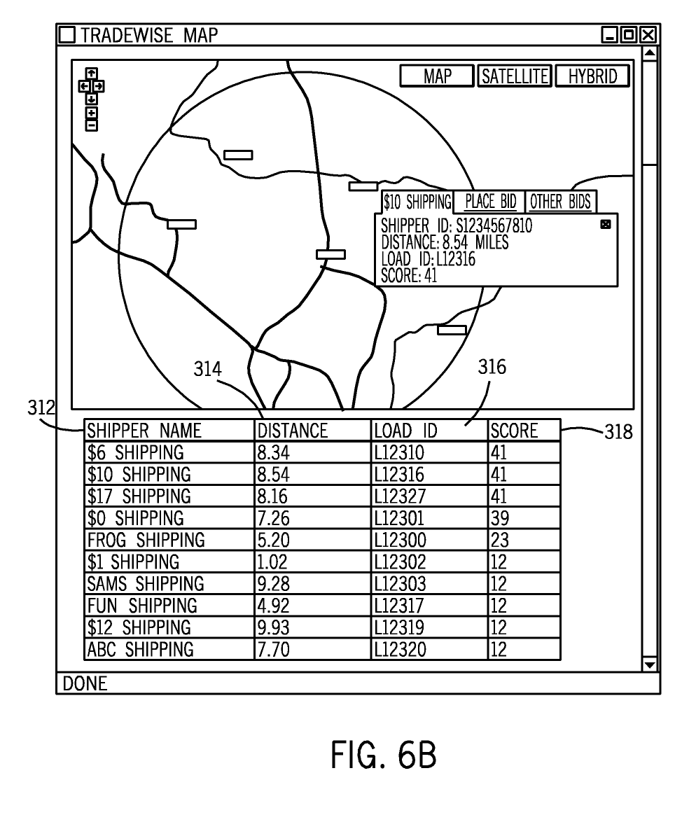

FIG. 6A is an exemplary map interface for the freight commerce system 10. The map 300 may show each of the possible shippers 14 within the purview of the map's boundaries. The map 300 may be zoomed in and out and shifted left, right, up or down, and additional features may enable users to select a map view, a satellite view, or a hybrid view. The hybrid view includes features of both the map 300 and the satellite view, such as a satellite picture overlaid with major roads, landmarks, and so forth. A user, such as a driver 20, may indicate location by selecting a location on the map 300. In certain embodiments, selection may be made by touching a display screen that is touch sensitive. In other embodiments, a mouse may be used to move a cursor and select a position. Alternatively, a driver 20 or user may indicate location by inputting latitude and longitude. This particular map 300 is directed toward enabling a driver 20 to locate potential shippers 14. The driver 20 may indicate a search radius and may limit the search parameters to show all shippers 14 or show only the best shippers 14, such as the ten shippers 14 who most accurately fit each of the driver's preference.

When the user has set preferences, indicated location, and/or selected a search radius, the driver 20 may select a “Map-It” icon 310 which will then process both the preference information as well as current location information for the driver 20 and provide the user with the result of the search. Specifically, as illustrated, the user indicated a search radius of ten miles from the indicated latitude and longitude and the search results may be provided as illustrated in FIG. 6B as including the shipper's name 312, the distance 314, the load ID 316, and the score 318 indicative of how close the shipper 14 met the driver's criteria or preferences. The driver 20 may then select the shipper preference listing, at which time the map 300 may indicate an information bubble with additional information on the shipper 14 and provide tabs to allow the driver 20 to place a bid and to view other bids that are available. Thus, the freight commerce system 10 allows for real-time performance metrics in each load trip based on a user defined weighting of evaluation criteria. Inputs from these criteria may be both manual and automated. Assessment of the performance metrics may form the basis for future contracts negotiations.

The freight commerce system 10 provides beneficial tools to negotiate custom contracts and helps ensure that the contract details are executed to the full precision that was agreed. Multi-attribute reputation building mechanisms from all of the participants, or actors, may be used as feedback for each of the transactions. As described above, the freight commerce system 10 may aggregate information related to the various actors. Specifically, for example, the freight commerce system 10 may be configured to store data relating to a driver's historical on-time performance. For instance, in certain embodiments, sensing/tracking devices may automatically update performance information where available. The data may be collected directly using the data collection devices or may be provided by other actors privy to a particular shipping/carrying agreement. For example, a shipper 14 may indicate that a carrier 20 arrived on-time, ahead of schedule, or was late. This information may be used by the freight commerce system 10 to build a reputation for the driver 20. Other information that may be used for performance assessment and reputation building may be obtained and/or learned from data collection devices (e.g., how much impact the driver 20 allows the load 18 to experience, and so forth). In fact, all of the types of information described herein may generally be input manually (e.g., input by a user about himself, input by a user about another user, and so forth) or collected automatically via data collection devices.

The freight commerce system 10 may be particularly beneficial for providing opportunities to smaller shippers 14 and carriers 20 that might otherwise be unavailable. For example, the ability of smaller shippers 14 and carriers 20 to access centralized real-time freight data (e.g., geo-based data, and so forth) makes available new opportunities for more proactively scheduling the types of loads that are shipped and carried, respectively. This capability affords these smaller shippers 14 and carriers 20 more control over their own businesses than they would otherwise have without the freight commerce system 10. However, the benefits of the freight commerce system 10 are not limited to smaller shippers 14 and carriers 20. The automated features of the freight commerce system 10 may also prove beneficial for larger freight commerce participants. For example, the ability to access the large, automated network of the freight commerce system 10 may enable larger market participants to more efficiently schedule shipments. In other words, all market participants may benefit from using the freight commerce system 10 described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A freight commerce system, comprising:
a server;
a communication network coupled to the server;
one or more data collection devices communicatively coupled to the communication network, wherein the one or more data collection devices are configured to provide location information to the server via the communication network, wherein the location information includes real-time geo-based information, historical geo-based information, or a combination thereof; and
one or more electronic devices coupled to the communication network and configured to receive user preference information from a user and provide the preference information to the server, wherein the server is configured to process the user preference information from the one or more electronic devices and the location information from the one or more data collection devices and provide the user with information for potential shipping business partners based on the user preference information and the location information.

2. The freight commerce system of claim 1, wherein the server is configured to provide the user and potential shipping business partners with agreement templates to allow the users to enter into a freighting arrangement.

3. The freight commerce system of claim 1, wherein the server is configured to store location information for each of the one or more data collection devices and determine route information based on the stored location information.

4. The freight commerce system of claim 1, wherein the server is configured to determine deviation from a route agreed upon by the user and a shipping business partner.

5. The freight commerce system of claim 1, wherein the one or more data collection devices are configured to provide one or more of the following parameters to the server: temperature, load vibration and impact events, access to a storage area, tire pressure, brake wear, bearing wear, and anti-lock braking system use.

6. The freight commerce system of claim 1, wherein the server is configured to compute performance metrics based on the user preference information, the location information, or a combination thereof.

7. The freight commerce system of claim 1, wherein the server is configured to provide a reputation building mechanism and valuation matrix rating based on the location information, the user preference information, performance metrics, user feedback, or a combination thereof.

8. The freight commerce system of claim 1, wherein the server is configured to facilitate negotiations between the potential shipping business partners based on the real-time geo-based information, analysis of the historical geo-based information, the user preference information, performance metrics, user feedback, or a combination thereof.

9. The freight commerce system of claim 1, wherein the server is configured to identify collaboration opportunities using the real-time and historical geo-based information.

10. The freight commerce system of claim 1, wherein the server is configured to adaptively learn additional user preference information based at least in part on the user preference information, actions taken by the user, the real-time and historical geo-based data, or a combination thereof.

11. A method for operating a freight commerce system, comprising:
receiving real-time data from a plurality of data devices via a communication network, wherein the data devices are located with goods or carriers;
receiving preference data from carriers and shippers via the communication network;
processing the real-time data from the plurality of data devices and the preference data from the carriers and shippers; and
providing carriers and shippers with a recommendation list based at least in part on the real-time data and the preference data.

12. The method of claim 11, comprising receiving real-time data relating to a load location, a load status, a load condition, or a combination thereof.

13. The method of claim 11, comprising learning additional preference data from the real-time data, the preference data, historical data, or a combination thereof.

14. The method of claim 11, comprising receiving preference data from a load, wherein the recommendation list is based at least in part on the preference data from the load.

15. The method of claim 11, wherein receiving preference data from carriers comprises one or more of the following: receiving future location information, receiving type of load information, and receiving preferred route or location information.

16. The method of claim 11, wherein receiving preference data from shippers comprises one or more of the following: receiving preferred route, receiving preferred time constraints, and receiving preferred temperature and handling conditions.

17. The method of claim 11, comprising providing current location information to a carrier, a shipper, and a receiver associated with a freight agreement.

18. The method of claim 11, comprising providing a rating by analyzing automated inputs and manual inputs.

19. The method of claim 18, comprising analyzing the real-time data to determine on-time performance and other performance metrics.

20. A shipping management system, comprising:
a data collection system, comprising:
a data collection device configured to obtain real-time data relating to a shipment load;
a communication network configured to transmit the real-time data; and
a central station configured to collect the real-time data; and
a server configured to receive the real-time data, to receive preference information from carriers or shippers via the communication network, to process the real-time data and the preference information, to learn behavioral characteristics of the carriers or shippers based at least in part on the real-time data and the preference information, and to provide the carriers or shippers with a recommendation list based at least in part on the learned behavioral characteristics of the carriers or shippers.
